(19) United States
(12) Patent Application Publication
(10) Pub. No.: US 2016/0327202 A1
(43) Pub. Date: Nov. 10, 2016

(54) WALL MOUNTING BRACKET

(71) Applicant: Karl Hoeltge, O'fallon, MO (US)

(72) Inventor: Karl Hoeltge, O'fallon, MO (US)

(21) Appl. No.: 15/215,086

(22) Filed: Jul. 20, 2016

Related U.S. Application Data
(63) Continuation-in-part of application No. 14/813,613, filed on Jul. 30, 2015.
(60) Provisional application No. 62/030,813, filed on Jul. 30, 2014.

(51) Int. Cl. F16M 11/40; F16B 47/00; A63H 3/50; A47F 5/08; A47F 7/00; F16M 13/02; F16M 11/04

(52) U.S. Cl. CPC F16M 11/40; F16M 13/02; F16B 47/003; F16M 11/041; A47F 5/0838; A47F 7/00; A63H 3/50; A47F 2007/0092

(57) ABSTRACT

A wall mounting bracket is provided. The wall mounting bracket is configured to allow a user to suspend a plurality of items thereon to be displayed from a wall surface. The wall mounting bracket includes a base portion configured to be placed flush against a wall surface and removably adhered thereto via any suitable fastening method. The base portion includes a plurality of adjustable shafts each configured to be bent to a user's desire and maintain a bent shape. Each of the adjustable shafts include a fastener configured to removably fasten to the desired display item.

### CROSS-REFERENCE TO RELATED APPLICATION

This application is a continuation-in-part of U.S. non-provisional application Se. No. 14/813,613, filed Jul. 30, 2015, which claims the benefit of priority of U.S. provisional application No. 62/030,813, filed Jul. 30, 2014 the contents of which are herein incorporated by reference.

### BACKGROUND OF THE INVENTION

The present invention relates to wall mounting devices. More particularly, the present invention provides a wall mounting bracket that allows items to be displayed from a wall surface. The wall mounting bracket includes a base portion removably securable to the wall surface and a plurality of adjustable shafts having a fastener configured to removably fasten to the desired display item.

Many people collect many different types of toys. Some people collect action figures, and others collect figurines. Generally, figurines are figures that have been created to represent a certain character. They typically are molded and have no movable body parts. Furthermore, these figurines are molded with a base to make it easier to stand them up for display. On the other hand, action figures are also toys that are created to represent particular characters, however, they are designed to have at least one movable body part. Action figures can be moved and posed in a variety of positions, but they are harder to display because they lack a base portion.

Generally, collectors can either keep their action figures or figurines within their original packaging. Either way, many collectors have a desire to display these action figures or figurines instead of storing them in a closet. One typical method of hanging these action figures or figurines is to hang them from a wall. Collectors push thumbtacks into the wall and use string to hang the action figures or figures from each thumbtack. Needless to say, sometimes these thumbtacks are not configured to support the weight of heavier items.

Therefore, there exists a need for a new and improved wall mounting bracket that allows a user to suspend heavier items thereon.

### SUMMARY OF THE INVENTION

In one aspect of the present invention, a wall mounting bracket, comprises: a base portion having an interior face and an exterior face, wherein said interior face is configured to be placed flush against a support surface and removably adhered thereto via an adhesive; a plurality of adjustable shafts each comprising: a first end and a second end, wherein said first end is secured to said base portion and said adjustable shaft extends outwardly from said exterior face, wherein said adjustable shaft is configured to be bent by a user and maintain a bent shape; and a fastener secured to said second end and configured to removably clamp an item thereon.

These and other features, aspects and advantages of the present invention will become better understood with reference to the following drawings, description and claims.

### BRIEF DESCRIPTION OF THE DRAWINGS

FIG. 1 is a perspective view of an embodiment of the wall mounting bracket of the present invention;

FIG. 2 is a bottom section view of an embodiment of the present invention illustrating the base portion and the extending shafts;

FIG. 3 is a top view of an embodiment of the base portion of the present invention;

FIG. 4 is a bottom view of an embodiment of the base portion of the present invention; and

FIG. 5 is a perspective view of an embodiment of the present invention in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

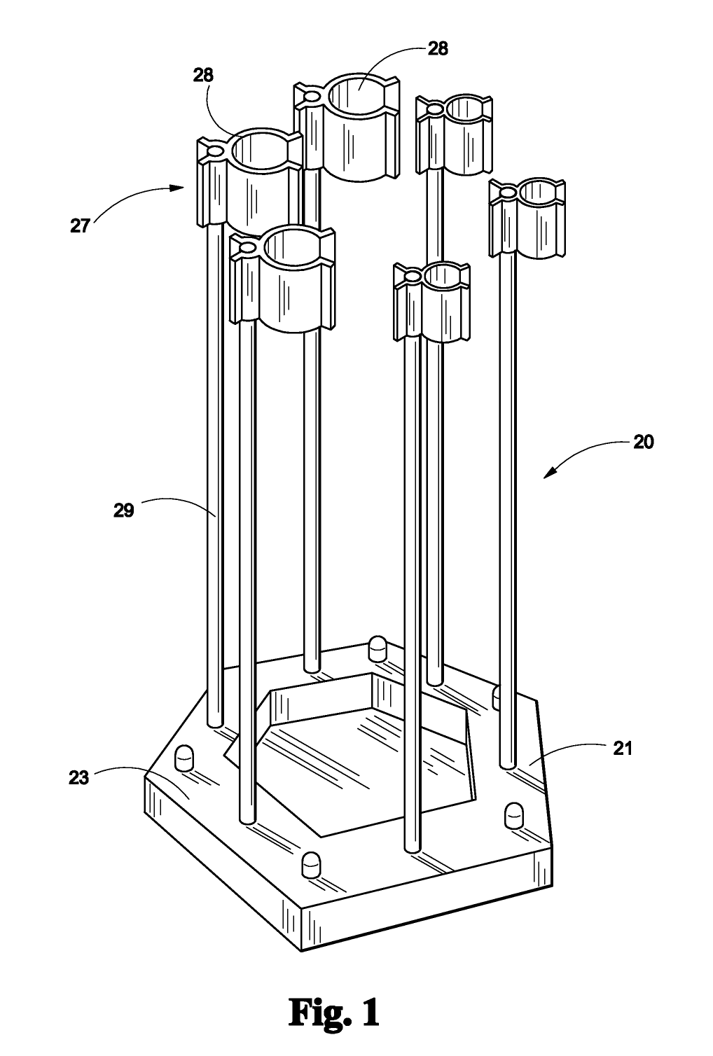

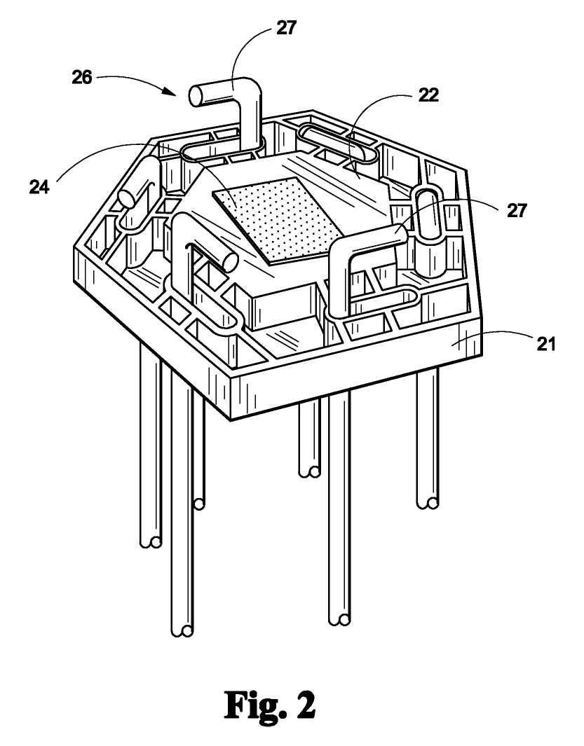

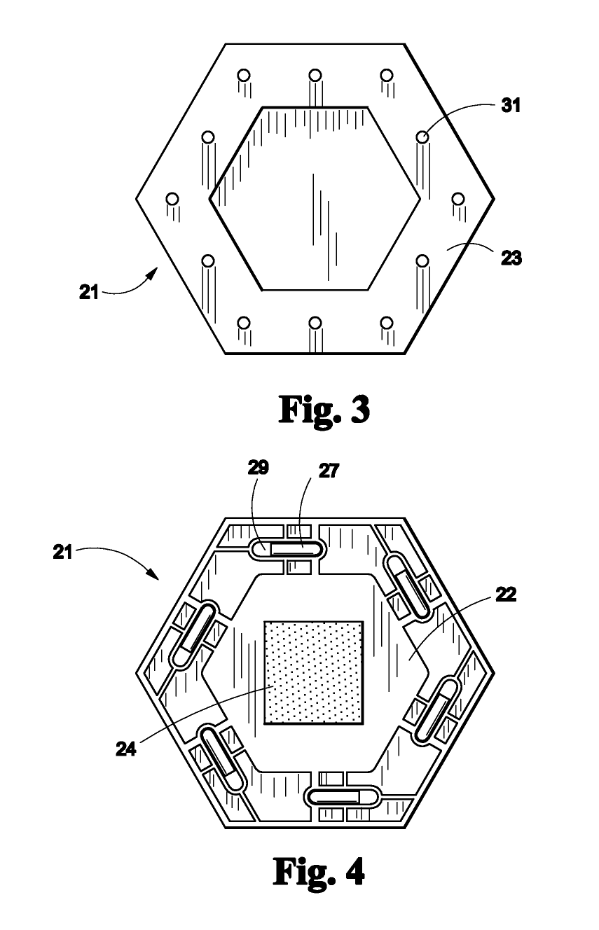

Referring now to FIGS. 1 through 5, the present invention includes a mounting bracket 20. The mounting bracket 20 is configured to removably mount a variety of items to a wall surface or other similar support surface. These items include various household items, toys, figurines, action figures, and the like. The mounting bracket 20 is particularly advantageous as it allows for users to hang various tools for easy access or suspend favorite items to provide a customized decor. The mounting bracket 20 includes a base portion 21 having an interior face 22 and an exterior face 23. The base portion 21 may be hexagonal in shape, however, other shapes and sizes of the base portion 21 are alternatively used in other embodiments. These variations and sizes are deemed within the spirit and scope of the inventive embodiments described herein. The interior face 22 is configured to be placed flush against a wall surface via an adhesive 24. The adhesive 24 may be a strong epoxy glue, however, other suitable means of adhesive are also likewise contemplated. In some embodiments, the interior face 22 is removably secured to a wall surface via a fastener, such as a bolt, screw, or nail, among others.

The exterior face 23 of the base portion 21 includes a plurality of adjustable shafts 25 extending outwardly therefrom. The plurality of adjustable shafts 25 may extend from a periphery of the base portion 21. For example, each side of the hexagonal shape may include one extending shaft 25 in an embodiment including six extending adjustable shafts 25. The adjustable shafts 25 includes a first end 26 and a second end 27, wherein the first end 26 is secured to the base portion 21. For example, the first end 26 of each of the adjustable shafts 25 may include a hook 27. The adjustable shaft 25 may fit through an aperture 31 formed through the base portion 21 and the hook 27 may rest within an indent 29 formed on the interior face 22. The second end 27 includes a fastener 28 configured to removably fasten an item thereon.

The adjustable shaft 25 may be composed of a flexible or bendable material, such as a metal wire, which is still rigid enough to maintain a bent configuration while supporting items thereon. In some embodiments, the adjustable shaft 25 is composed from a gooseneck that allows for adjustment. In this way, the user can manipulate and bend the adjustable shaft 25 in order to reposition an item supported thereon without having to detach the base portion 21 from the wall surface.

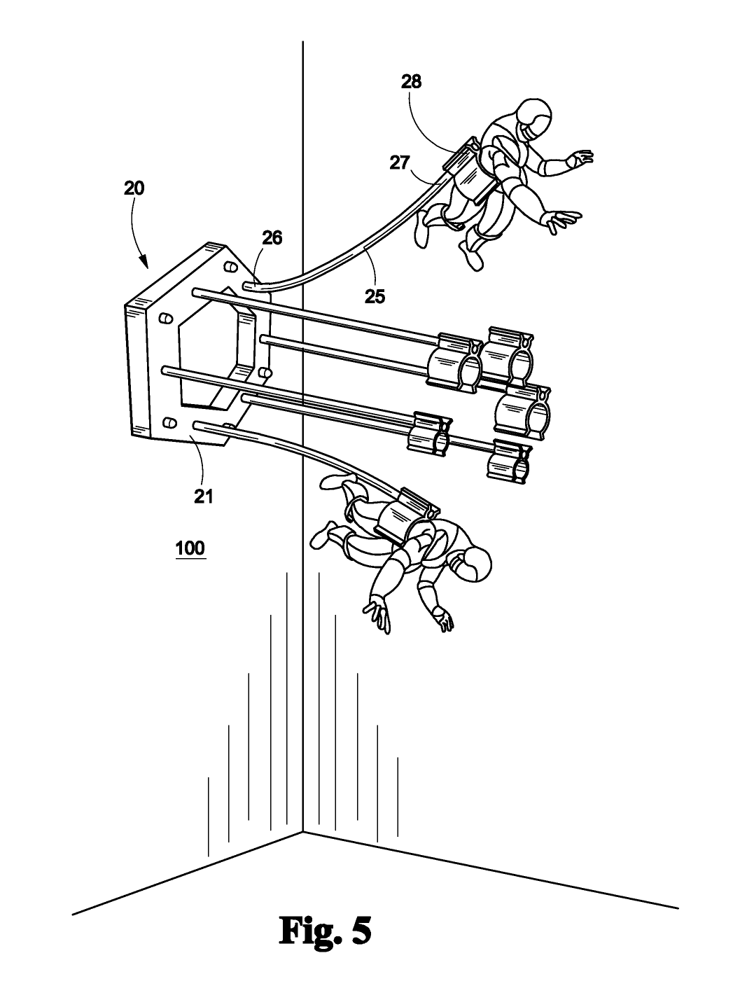

Referring now to FIG. 5, there is shown a side perspective view of the mounting bracket 20 in use. The interior face of the base portion 21 is placed flush against the wall surface 100. The adjustable shafts 25 extend outwardly from the exterior face 23 of the base portion 21. The adjustable shafts 25 are configured to be bent and manipulated to the user's desire in order to support an item thereon. Furthermore, the adjustable shaft 25 is also configured to maintain the bent shape manipulated by the user. The first end 26 of each of the adjustable shafts 25 are secured the exterior face 23 of the base portion 21 and the second end 27 includes the fastener 28. The fastener 28 is configured to removably fasten to an item, such as the figurine illustrated, via clamping. The fastener 28 may be a C-shaped clamp, however, other suitable fasteners are alternatively used in other embodiments and therefore, likewise contemplated within this present disclosure. In certain embodiments, different sized C-shaped clamps may be secured to different adjustable shafts 25. For example, a first set of C-shaped clamps may include a smaller diameter and a second set of C-shaped clamps may include a larger diameter.

In operation, a user can position a portion of the body of an action figure or figurine within the C-shaped clamp. The action figure fits frictionally within the clamp so that the action figure is partially encircled by the clamp. In some embodiments, the clamp is adjustable so that the tightness of the clamp on the action figure can be readily adjusted by the user.

It should be understood, of course, that the foregoing relates to exemplary embodiments of the invention and that modifications may be made without departing from the spirit and scope of the invention as set forth in the following claims.

What is claimed is:

1) A wall mounting bracket, comprising:
a base portion having an interior face and an exterior face, wherein said interior face is configured to be placed flush against a support surface and removably adhered thereto via an adhesive;
a plurality of adjustable shafts each comprising:
a first end and a second end, wherein said first end is secured to said base portion and said adjustable shaft extends outwardly from said exterior face, wherein said adjustable shaft is configured to be bent by a user and maintain a bent shape; and
a fastener secured to said second end and configured to removably clamp an item thereon.

2) The wall mounting bracket of claim 1, wherein said base portion comprises a hexagonal shape comprising six sides.

3) The wall mounting bracket of claim 2, wherein said plurality of adjustable shafts comprises six adjustable shafts each extending from one of said six sides respectively.

4) The wall mounting bracket of claim 1, wherein said fastener includes a C-shaped clamp.

5) The wall mounting bracket of claim 1, wherein said fastener comprises a C-shaped clamp, wherein said wall mounting bracket comprises a first set of smaller diameter C-shaped clamps and a second set of larger diameter C-shaped clamps.
